(19) United States
(12) Patent Application Publication
(10) Pub. No.: US 2023/0096436 A1
(43) Pub. Date: Mar. 30, 2023

(54) ADAPTIVE LIGHT BARRIER PROCESSING

(71) Applicant: STRATEC SE, Birkenfeld (DE)

(72) Inventor: Thilo Habrich, Bad Wildbad (DE)

(21) Appl. No.: 17/878,266

(22) Filed: Aug. 1, 2022

(30) Foreign Application Priority Data
Sep. 24, 2021 (GB) GB2113627.0

(51) Int. Cl. G01N 21/59; G01N 35/10

(52) U.S. Cl. CPC G01N 21/59; G01N 35/1004

(57) ABSTRACT

A method for adaptive signal processing of each trace originating from the photosensor. The method comprises an automatic detection of the voltage level of the target signal and the background noise. Based on the determined voltages advantageous decision limits are calculated. Such decision limits can be used to detect, for example, the temporal length of the signal. Due to a dynamic calculation of the decision limits, these limits are optimal for each measured voltage curve. The system is also able to detect a measurement with only noise and mark it as incomplete.

### CROSS-REFERENCE TO RELATED APPLICATION

The present application claims priority to British Patent Application No. GB2113627.0 filed on Sep. 24, 2021. The aforementioned application is hereby incorporated by reference in its entirety.

### BACKGROUND OF THE INVENTION

### Field of the Invention

The invention relates to a method for adaptive signal processing.

### Brief Description of the Related Art

Automated analyser systems for use in clinical diagnostics and life sciences are produced by a number of companies. For example, STRATEC® SE, Birkenfeld, Germany, produces a number of devices for specimen handling and detection for use in automated analyser systems and other laboratory instrumentation.

STRATEC® designs and manufactures automated analytical systems in the field of in vitro diagnostics (IVD), which use a number of individual instrument components to process diagnostic assays. One important component in such devices relates to the washing stations for rinsing the samples prior to their measurement. Light barriers have already been used for process control, i.e., for a qualitative analysis of individual aspirations by measuring the aspiration times. However, due to the static implementation of the system, there is insufficient differentiation between signal and background noise in the evaluation.

As already mentioned, IVD devices for processing diagnostic assays, comprise many individual device components, hereinafter also referred to as modules. These modules take over individual processing steps in the sequence of processing the samples. The functionality required for these processing steps is provided by the firmware of the modules. Generally, data is collected during the processing of samples and checked by means of a process control. Process control is used to analyze the collected parameters and to ensure a correct analysis procedure. If an erroneous behavior is detected during process control, the currently processed sample is discarded, if necessary.

A central task of processing samples in IVD devices is the movement of liquids, or the correct transport of consumables comprising a sample such as cuvettes during processing in the device. For both processes, an accurate assessment of the amount of liquid and the position of the consumables is crucial. These processes can be monitored using light barrier sensors. A light source shines through the medium to be measured for a defined time per measurement. To that end the light intensity is measured with a photodiode which is arranged usually opposite to the light source. The measured light signal is recorded as varying voltages which must now be analyzed to distinguish between the actual signal and the background noise.

Published U.S. Pat. No. 5,777,221 discloses a failsafe apparatus for verifying a volume of aspirated reagent before it is provided to dilute a sample in an automated assay instrument. A pump draws reagent through a tube having a reagent probe disposed at one end. An optical flow detector includes an optical source disposed proximate the tube to illuminate the interior of the tube, and a photodetector oriented ninety degrees about the circumference of the tube from the source to detect reflected illumination from the contents of the tube. The photodetector provides one voltage level with gas/air within the tube, and a second level with a liquid within the tube. A circuit in communication with the detector discriminates between the two levels. The rate at which aspirate is pumped and the volume of the tube from a probe tip inlet to the detector are known constants. Therefore, a given volume of aspirate takes a predictable amount of time to pass from tip to detector. The actual time is determined by measuring the elapsed time between the start of the aspiration of a reagent, and a liquid-air transition detected at the end of the aspirated reagent. If the liquid-air transition is not seen at the expected time, one of several problems with the system are assumed, and the assay is canceled. The disadvantage of the disclosed apparatus and method relates to the fact that no adaptive signal processing is provided.

Static process control known from the prior art like U.S. Pat. No. 5,777,221 for distinguishing between signal and background noise may lead to incorrect evaluations in certain cases. The reason for this is the static approach of signal processing. The known approach can only react in discrete steps to changes in the media arranged between the light source and the photodiode. This is done in the context of a regular recalibration of the system. The sensor system cannot react to changes of the media in the system between two calibrations. This circumstance can lead to errors in the evaluation.

Thus, there is a need to provide a device for adaptive signal processing when monitoring washing processes in automated analyzer systems.

### SUMMARY OF THE INVENTION

It is therefore the object of this invention to provide a device and a method for adaptive signal processing when monitoring washing processes in automated analyzer systems

The present invention provides a method for adaptive signal processing, comprising the steps of illuminating the content in a container with a light source from one side of the container; measuring the optical signal with a sensor resulting from light shining through the container and its content; assigning voltage values to the measured optical signals; preparing a voltage curve from sampled measurements of voltage values over time; defining a voltage level for expected target signals; performing a first plausibility check by comparing a median of voltage values from the beginning of the voltage curve with the defined voltage level for an expected signal; alternatively stopping the method if the median of voltage values from the beginning is higher than 50% compared to the defined voltage level for an expected signal, or proceeding with the method if the median of voltage values from the beginning is higher than 50% compared to the defined voltage level for an expected signal by reducing the voltage values by a defined factor to a present fallback level; lower than the defined voltage level for an expected signal; if proceeding, determining the voltage level of a target signal by calculating the median of a group of the highest measured voltage values with a noise level or the fallback level; alternatively stopping the method if the median of a group of highest voltage values is less than 20% higher compared to the defined voltage values of a noise level or a fallback level, or proceeding with the method if the median of the group of highest voltage values is at least 20% higher compared to the defined voltage values of a noise level or a fallback level; determining discrimination limits between the voltage values relating to a noise level and a target level, respectively, by setting the discrimination limit in the middle between the noise level and signal level.

Another aspect of the present invention relates to the step of determining voltage values in a running process for process control.

In another embodiment of the method according to the present disclosure, it is envisaged that the median of voltage values from the beginning comprises the median value of pre-defined number of measured voltage values.

It is further intended that the median of the group of highest voltage values is defined from a pre-defined number of measured highest voltage values.

In a further aspect of the present invention, the method is stopped if the median of the group of highest voltage values is at least 50% higher compared to the defined voltage values of a noise level or a fallback level.

The method may comprise in another embodiment the step of measuring optical signal in a sample with a known concentration of a target for obtaining a voltage value for an expected target signal.

The method may also comprise the step of measuring optical signal in a sample without a target for obtaining a voltage value for a noise level.

The method refers to the understanding of a container being bottle, vessel, cuvette, tube, hose or a channel.

Another object of the present disclosure relates to a method for process control of samples which are optically evaluated in a device comprising the steps of applying a method as described above.

Still other aspects, features, and advantages of the present invention are readily apparent from the following detailed description, simply by illustrating preferable embodiments and implementations. The present invention is also capable of other and different embodiments and its several details can be modified in various obvious respects, all without departing from the spirit and scope of the present invention. Accordingly, the drawings and descriptions are to be regarded as illustrative in nature, and not as restrictive. Additional objects and advantages of the invention will be set forth in part in the description which follows and in part will be obvious from the description or may be learned by practice of the invention.

### BRIEF DESCRIPTION OF THE FIGURES

The invention will be described based on figures. It will be understood that the embodiments and aspects of the invention described in the figures are only examples and do not limit the protective scope of the claims in any way. The invention is defined by the claims and their equivalents. It will be understood that features of one aspect or embodiment of the invention can be combined with a feature of a different aspect or aspects of other embodiments of the invention, in which:

FIG. 1 shows a plausibility check on an exemplary voltage curve.

FIG. 2 shows example of a faulty voltage curve.

FIG. 3 shows an example voltage curve that has successfully completed all plausibility checks.

### DETAILED DESCRIPTION OF THE INVENTION

The technical problem is solved by the independent claims. The dependent claims cover further specific embodiments of the invention.

A container within the meaning of the present invention refers to any receptacle that is appropriate to comprise a fluid like a liquid, gas, or any other material that may flow under external force or shear stress. Thus, a container also refers to a hose, tube or a channel which may comprise a fluid or through which a fluid may flow. A container shall also be understood to be a well of a multi well plate or a bottle.

One object of the present invention relates to a system comprising a light source and a photosensor. Another object of the invention relates to a method for adaptive signal processing of each trace originating from the photosensor. The method comprises an automatic detection of the voltage level of the target signal and the background noise. Based on the determined voltages advantageous decision limits are calculated. Such decision limits can be used to detect, for example, the temporal length of the signal. Due to a dynamic calculation of the decision limits, these limits are optimal for each measured voltage curve. The system is also able to detect a measurement with only noise and mark it as incomplete.

The subject matter of the present disclosure is based on using methods for adaptive signal processing of voltage curves. For this purpose, the continuous voltage measurements collected by optical sensors built into the instrument are evaluated. A voltage curve within the meaning of the present disclosure is a sampled measurement of voltages from a photodiode over time, wherein the photodiode measures light intensities through a medium which is comprised in a container or consumable or flows through a hose, tube or channel.

During the monitored process, the voltage of the photodiode is recorded at a high frequency. The measured voltage levels differ depending on the kind of medium which is between light source and sensor at the respective time. For these systems, a calibration is usually performed to obtain a comparable voltage level (target value of the system calibration) for the background noise over time. The calibration is performed on all instruments according to the same scheme to allow comparability between the instruments.

In the voltage curve, the period with signal should now be distinguished from the period with background noise. For this purpose, the voltage level of the background noise, which is usually present at the beginning of each curve, is first determined for each individual voltage curve. For this purpose, for example, the first 40 values of the curve are analyzed, and the median of these values is calculated. Here, a plausibility check is performed to verify whether the target signal is already present at the beginning of the measurement. This case is assumed if the measured voltage at the beginning of the curve is more than 50% higher than the target value of the system calibration. In this case the voltage level is assessed to be too high, so that a preset fallback for the voltage level for the noise is assumed, to allow for the calculation to take place. The value of the fallback depends on the application.

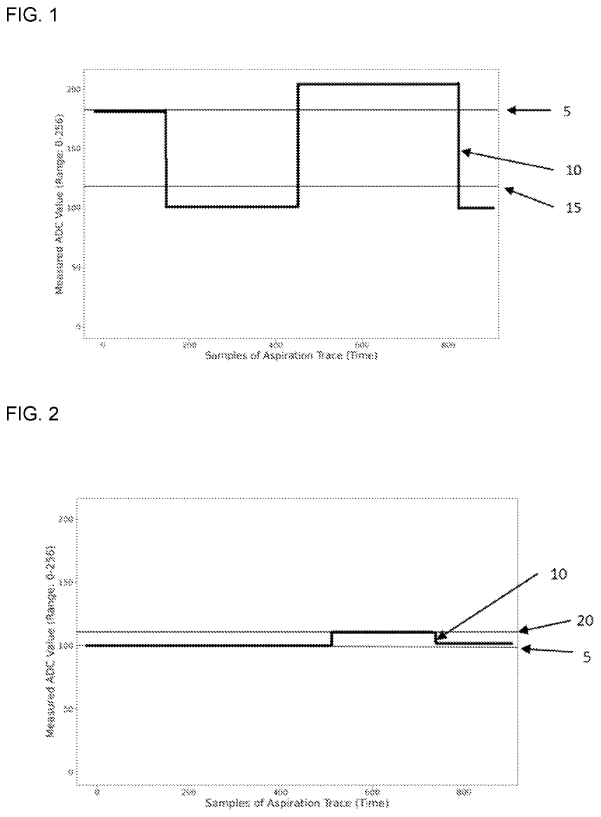

FIG. 1 illustrates such a case of plausibility check on an exemplary voltage curve. The algorithm has determined a noise level 5 of approximately 180 from the first 40 values of the voltage curve 10. The determined noise level is 80% above the specified target value of 100 and thus outside the tolerance range of 50%. In this case, the voltage value of the first 40 determined values is too high. As a result of the plausibility check, a preset fallback 15 with a fixed voltage level of e.g., 120 is assumed for the further evaluations.

The procedure of the first plausibility check depends on the target application. In critical applications, a preset fallback is not permitted. With these voltage curves, if the voltage level of the background noise is increased, the voltage curve is generally marked as faulty.

After the plausibility check, the voltage level of the target signal is determined. This is done, for example, by sorting the 5 highest values of the trace and calculating the median of these values. This is done to compensate for individual error measurements of the voltage. In the next plausibility check, it is checked whether a sufficiently large voltage difference can be detected in the curve at all. Depending on the application, the calculated levels should differ at least by 20-30%. If the voltage difference is too low, the curve is marked as faulty during the second plausibility check.

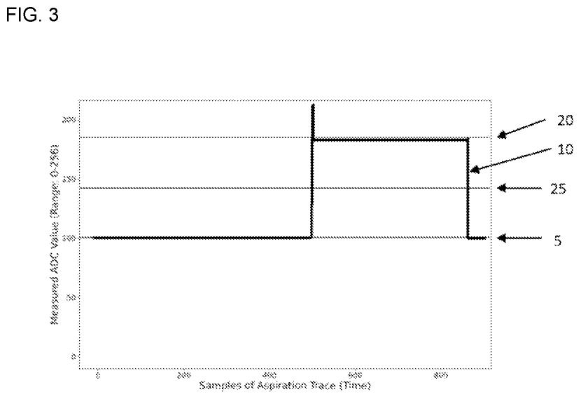

An example of a faulty voltage curve is shown in FIG. 2. For this voltage curve 10, the determined noise level 5 is within the specifications from the first plausibility check. In this example, the determined noise level 5 is 100. After determining the five highest values from the voltage curve 10, the calculation of the median results in a value of 110 for the signal level 20. The voltage difference of the calculated levels is thus 10% and is below the specified minimum difference. Consequently, the discrimination of the calculated levels is too small for the further evaluations. The second plausibility check marks the curve shown in FIG. 2 as faulty.

When all plausibility checks are completed, optimal discrimination limits between the voltage of the noise and the signal are determined. For this purpose, the discrimination limit is set exactly in the middle between the two calculated levels. The resulting calculated boundary now allows a distinction between noise level and signal level. This boundary is used to determine the length of the target signal above the boundary. The result can then be used for further process controls.

FIG. 3 shows an example voltage curve 10 that has successfully completed all plausibility checks. From the analysis of the first 40 values of the voltage curve 10, the algorithm determined a noise level 5 of 100. For the first plausibility check, the determined noise level 5 is within the tolerance range of the target value of the system calibration. Now, in the second plausibility check, the voltage difference of the calculated levels is determined. By calculating the median of the five highest values from the voltage curve 10, a signal level 20 of 180 was determined. There is thus a sufficiently large voltage difference of 80% between the noise level 5 and the signal level 20, so that the calculated limit 25 of 140 is obtained in the middle of the two levels 5, 20. Signals below the limit 25 of 140 are thus noise level 5 and values above the limit 25 of 140 are target signals. This distinction can now be used for process controls.

The advantages of a method according to the present invention compared to static signal processing known from the state of the art relate to adaptive signal processing. As described, static signal processing cannot adapt to changes in the measurement system without recalibration. In contrast, adaptive signal processing can adapt to both spontaneous and gradual changes in the measurement system. Therefore, the evaluation is always best possible despite variations in the measurement system. Furthermore, adaptive signal processing allows the implementation of plausibility checks. It can be checked whether the measurement contains a signal at all or whether the signal occurs at the wrong time during the measurement.

Various alternative approaches for adaptive signal processing are conceivable. One possibility is to recalibrate the measurement system very regularly when using static signal processing. However, such frequent recalibration is not practical since this takes some time and therefore cannot be performed regularly during the day without slowing down the processing.

Another alternative is to manually inspect the measurement system on a regular basis to detect any deviations and correct them if necessary. This would also be a very time-consuming procedure, which would require trained personnel.

The foregoing description of the preferred embodiment of the invention has been presented for purposes of illustration and description. It is not intended to be exhaustive or to limit the invention to the precise form disclosed, and modifications and variations are possible considering the above teachings or may be acquired from practice of the invention. The embodiment was chosen and described to explain the principles of the invention and its practical application to enable one skilled in the art to utilize the invention in various embodiments as are suited to the particular use contemplated. It is intended that the scope of the invention be defined by the claims appended hereto, and their equivalents. The entirety of each of the aforementioned documents is incorporated by reference herein.

### REFERENCE NUMERALS

5 noise level
10 voltage curve
15 fallback
20 signal level
25 limit

What is claimed is:

1. A method for adaptive signal processing, comprising the steps of illuminating the content in a container with a light source from one side of the container;
measuring the optical signal with a sensor resulting from light shining through the container and its content;
assigning voltage values to the measured optical signals;
preparing a voltage curve from sampled measurements of voltage values over time;
defining a voltage level for expected target signals;
performing a first plausibility check by comparing a median of voltage values from the beginning of the voltage curve with the defined voltage level for an expected signal;
alternatively
stopping the method if the median of voltage values from the beginning is higher than 50% compared to the defined voltage level for an expected signal, or
proceeding with the method if the median of voltage values from the beginning is
higher than 50% compared to the defined voltage level for an expected signal by reducing the voltage values by a defined factor to a present fallback level;
lower than the defined voltage level for an expected signal;
if proceeding, determining the voltage level of a target signal by calculating the median of a group of the highest measured voltage values with a noise level or the fallback level;
alternatively
stopping the method if the median of a group of highest voltage values is less than 20% higher compared to the defined voltage values of a noise level or a fallback level, or
proceeding with the method if the median of the group of highest voltage values is at least 20% higher compared to the defined voltage values of a noise level or a fallback level;
determining discrimination limits between the voltage values relating to a noise level and a target level, respectively, by setting the discrimination limit in the middle between the noise level and signal level.

2. The method of claim 1, comprising the step of determining voltage values in a running process for process control.

3. The method of claim 1, wherein the median of voltage values from the beginning comprises the median value of pre-defined number of measured voltage values.

4. The device of claim 1, wherein the median of the group of highest voltage values is defined from a pre-defined number of measured highest voltage values.

5. The method of claim 1, wherein the method is stopped if the median of the group of highest voltage values is at least 50% higher compared to the defined voltage values of a noise level or a fallback level.

6. The method of claim 1, comprising the step of measuring optical signal in a sample with a known concentration of a target for obtaining a voltage value for an expected target signal.

7. The method of claim 1, comprising the step of measuring optical signal in a sample without a target for obtaining a voltage value for a noise level.

8. The method of claim 1, wherein a container is bottle, vessel, cuvette, tube, hose or a channel.

9. A method for process control of samples which are optically evaluated in a device comprising the step of applying a method according to claim 1.
